(19) United States
(12) Patent Application Publication
(10) Pub. No.: US 2016/0062395 A1
(43) Pub. Date: Mar. 3, 2016

(54) MULTI-SCREEN DISPLAY DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: YAN-BIN LIU, Shenzhen (CN); LONG YU, Shenzhen (CN)

(21) Appl. No.: 14/695,471

(22) Filed: Apr. 24, 2015

(30) Foreign Application Priority Data
Sep. 2, 2014 (CN) 201410441938.7

(51) Int. Cl. G06F 1/16; G06F 3/041; G06F 3/0488

(52) U.S. Cl. CPC G06F 1/1618; G06F 3/04886; G06F 3/041

(57) ABSTRACT

A multi-screen display device includes a first display unit and a second display unit. The first display unit includes at least one first display screen, and the second display unit includes at least one first display screen. The first display unit is rotatably coupled to the second display unit so that the first display screen and the second display screen are positionable substantially on a single plane. When the first display screen and the second display screen are positioned on a single plane, the first display screen is in close proximity to the second display screen and the first display screen and the second display screen cooperate to form a combined display area larger than the first display screen.

### FIELD

The subject matter herein generally relates to a multi-screen display device, and more particularly, to a folded multi-screen portable electronic device.

### BACKGROUND

Electronic devices having large screens, such as mobile terminals and laptop computers, are increasingly popular now, as the large screens are ideal for viewing videos and convenient to operate. However, the electronic devices having large screens are not convenient to carry.

### BRIEF DESCRIPTION OF THE DRAWINGS

Implementations of the present technology will now be described, by way of example only, with reference to the attached figures.

FIG. 1 is an isometric view of a first embodiment of a multi-screen display device.

FIG. 2 is an exploded view of the multi-screen display device shown in FIG. 1.

FIG. 3 is an exploded view of the multi-screen display device shown in FIG. 1 from another angle.

FIG. 4 is an isometric view of the multi-screen display device shown in FIG. 1 when the multi-screen display device is unfolded.

FIG. 5 is an isometric view of a second embodiment of a multi-screen display device.

FIG. 6 is an isometric view of the multi-screen display device as shown in FIG. 5 when the multi-screen device is unfolded.

FIG. 7 is an isometric view of the multi-screen display device as shown in FIG. 5 when the multi-screen device opening.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series and the like.

The present disclosure is described in relation to multi-screen display device.

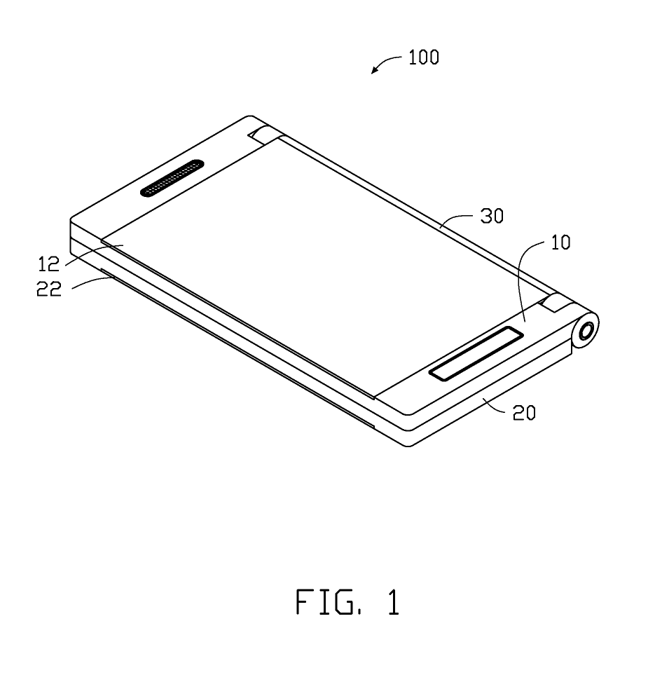

FIG. 1 illustrates that a multi-screen display device 100 includes a first display unit 10, a second display unit 20, and a stylus 30. The second display unit 20 can be rotatably coupled to the first display unit 10 by a hinge (not shown). The first display unit 10 can communicate with the second display unit 20 by wire connection, wireless connection, or dock. The stylus 30 can be detachably mounted on the first display unit 10 or the second display unit 20. Users can use the stylus 30 to input on the first display unit 10 or the second display unit 20.

The first display unit 10 can have a first display screen 12 and the second display unit 20 can have a second display screen 22 defined thereon. The first display unit 10 is rotatably coupled to the second display unit 20 so that the first display screen 12 and the second display screen 20 are positionable substantially on a single plane. In at least one embodiment, the first display screen 12 can display a first user interface alone. When the first display screen 12 and the second display screen 22 are positioned on a single plane, the first display screen 12 and the second display screen 22 can cooperatively form a combined display area larger than the first display screen 12, and the combined display area can display a second user interface larger than the first user interface displayed by the first display screen 12 alone. In other embodiments, the second display screen 22 can also display the first user interface.

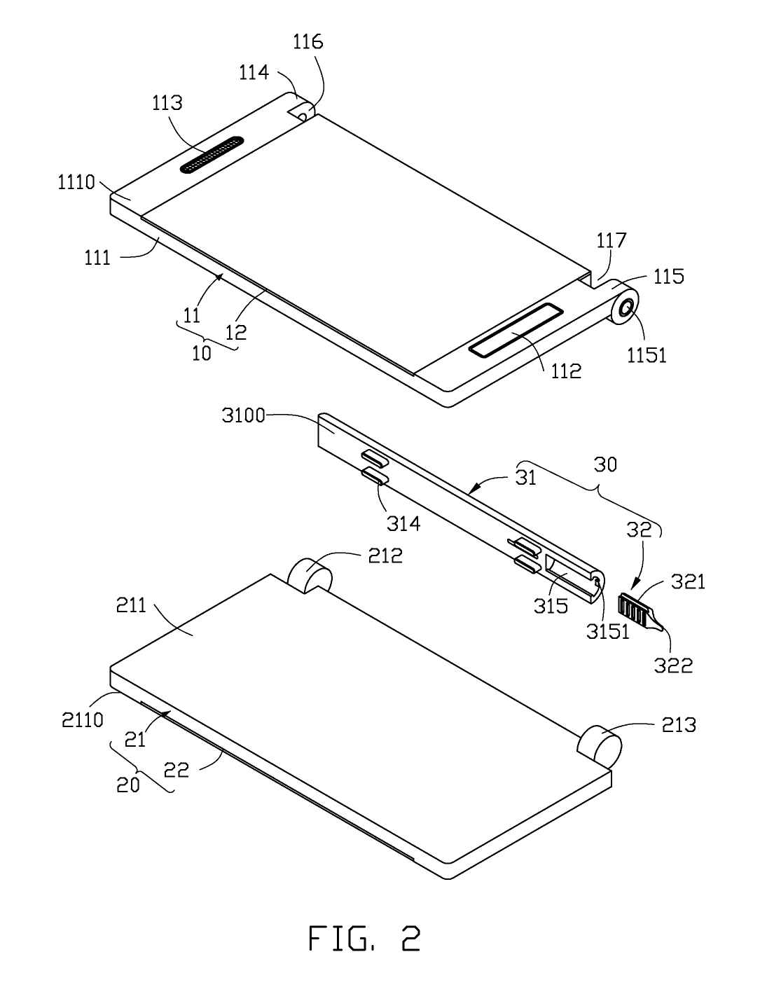

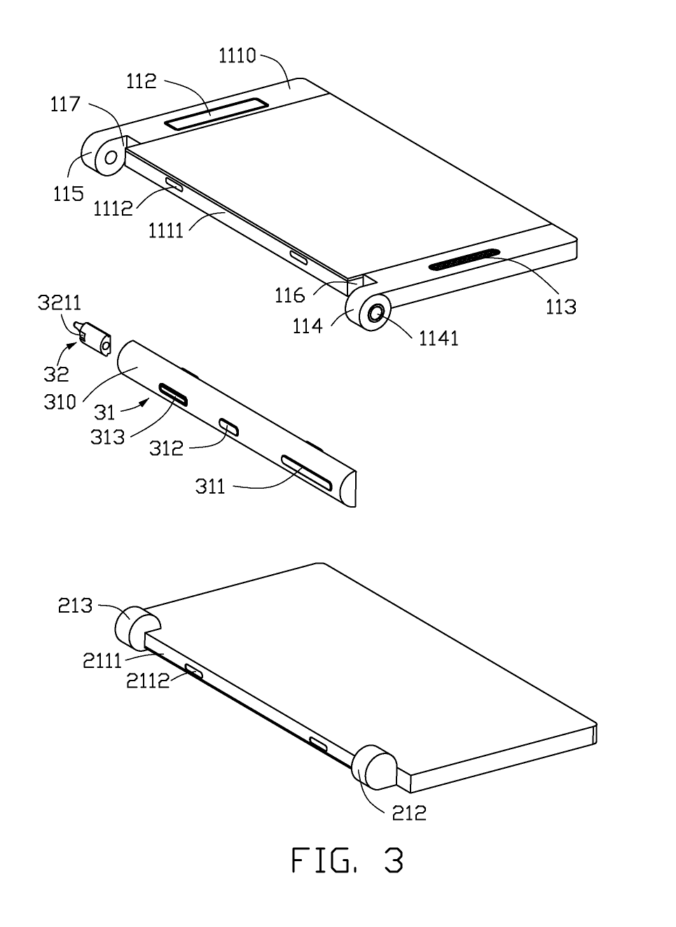

FIG. 2 and FIG. 3 illustrate that the first display unit 10 can further include a first housing 11, and the first display screen 12 can be mounted in the first housing 11. The first housing 11 can include a first main body 111, and the first main body 111 can include a first surface 1110 and a first side surface 1111 adjacent to the first surface 1110. The first housing 11 can further include a control key 112 and sound holes 113 arranged on the first surface 1110, at least one first slot 1112 arranged on the first side surface 1111, and a first pivot 114 and a second pivot 115 protrude out of two ends of the first side surface 1111 along a direction perpendicular to the first side surface 1111. The first pivot 114 and the second pivot 115 can be coaxial. One side of the first pivot 114 away from the second pivot 115 can include an earphone jack 1141, and an earphone (not shown) can be inserted in the earphone jack 1141 to output sounds. One side of the second pivot 115 away from the first pivot 114 can define a power port 1151, and a power connector (not shown) can be inserted in the power port 1151 to supply power to the multi-screen display device 100.

The first display device 10 can further include a printed circuit board, a battery, a signal module, and other electronic elements (not shown).

The first pivot 114 and the first main body 111 can cooperatively define a first receiving groove 116, and the second pivot 115 and the main body 111 can cooperatively define a second receiving groove 117.

The first display screen 12 can be mounted on the first surface 1110 and configured to display the first user interface.

The second display unit 20 can further include a second housing 21, and the second display screen 22 can be mounted in the second housing 21. The second housing 21 can include a second main body 211. The second main body 211 can include a second surface 2110 opposite to the first surface 1110 and a second side surface 2111 adjacent to the second surface 2110. The second housing 21 can further include at least one second slot 2112 arranged on the second side surface 2111, a third pivot 212 and a fourth pivot 213 protrude out of two ends of the second side surface 2111 along a direction perpendicular to the second side surface 2111. The third pivot 212 and the fourth pivot 213 can be coaxial, and a maximum distance between the third pivot 212 and the fourth pivot 213 can be smaller than a minimum distance between the first pivot 114 and the second pivot 115.

The second display screen 22 can be mounted on the second surface 2110 and configured to display an first user interface along or display the same first user interface as the first display screen 12.

The stylus 30 can include a pen holder 31 and a pen point 32 received in the pen holder 31. The pen holder 31 can be half cylinder shaped, and include a half cylindrical surface 310 and a pen holder side surface 3100. The pen holder 31 can further include a volume key 311, a power button 312, and a data port 313 arranged on the half cylindrical surface 310. The volume key 311 can be configured to control the volume output from the first display unit 10 or the second display unit 20, and the power button 312 can be configured to turn on or shut off the multi-screen display device 100. A data interface (not shown) can get through the data port 313 to insert in a data port of the first display device 10 or the second display unit 20 for data transmission. In other embodiments, the stylus 30 can be detached from the multi-screen display device 100, and the volume and the power can be controlled by software. The data transmission of multi-screen display device 100 can be achieved by wireless connection.

The pen holder side surface 3100 can include two protrusions 314 corresponding to the first slot 1112 and the second slot 2112. One end of the pen holder 31 adjacent to the side surface 3100 can define a concave portion 315, and the concave portion 315 can include a projection 3151 at the opening. The pen point 32 can include a main body 321 and a nip 322 positioned at one end of the main body 321. One end of the main body 321 near the nip 322 can define a groove 3211, and the groove 3211 can be engaged with the projection 3151, thereby the pen point 32 would not drop off the pen holder 31.

In assembly, the third pivot 212 and the fourth pivot 213 of the second display unit 20 can be received in the first receiving groove 116 and the second receiving groove 117. The first pivot 114, the second pivot 115, the third pivot 212, and the fourth pivot 213 can be coaxial, thereby the first display unit 10 and the second display unit 20 can be connected by the hinge. Then, the projection 3151 of the pen holder 31 can be engaged with the groove 3211, and the pen point 32 can be received in the pen holder 31. After that, the protrusions 314 of the stylus 30 can be inserted in the first slot 1112 and the second slot 2112.

The first display unit 10 or the second display unit 20 can be rotated until the first display screen 12 is opposite to the second display screen 22. The protrusions 314 can be inserted to the first slot 1112 and the second slot 2112, and the multi-screen display device 100 can display the first user interface which is smaller.

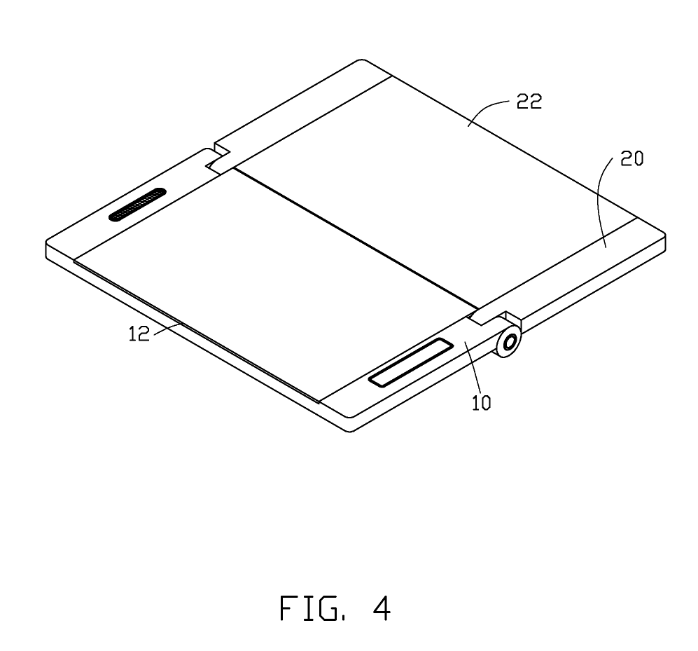

The stylus 30 can be detached from the multi-screen display device 100, and the first display unit 10 or the second display unit 20 can be rotated, such that the first display screen 12 and the second display screen 22 can be positioned on a single plane. FIG. 4 illustrates that the first display screen 12 and the second display screen 22 can be coplanar and form an angle of 180 degrees when the multi-display device 100 is unfolded. The first display screen 12 can be in close proximity to the second display screen 22 without any space to display the second user interface which is larger.

In other embodiments, the volume key 311, the power button 312, and the data port 313 can be arranged on the first display unit 10 or the second display unit 20.

In other embodiments, the stylus 30 can be coupled to the first display unit 10 and the second display unit 20 by a slide rail or other elements.

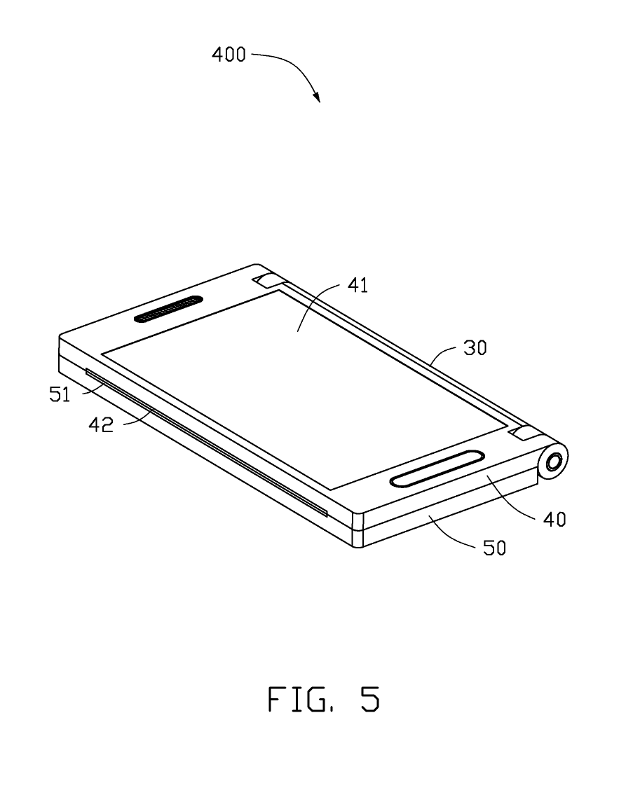

FIG. 5 illustrates a multi-screen display device 400 of a second embodiment of this disclosure. The multi-screen display device 400 of the second embodiment is similar to the multi-screen display device 100 of the first embodiment, except that, the multi-screen display device 400 includes a first display screen 41, a third display screen 42, and a second display screen 51. The multi-screen display device 400 can include a first display unit 40, a second display unit 50 rotatably coupled to the first display unit 40, and a stylus 30 same as the stylus of the first embodiment. The first display screen 41 can be mounted on an upper surface of the first display unit 40, and the third display screen 42 can be mounted on an lower surface of the first display unit 40. The second display screen 51 can be mounted on the an upper surface of the second display module 50 opposite to the lower surface of the first display unit 40.

When the multi-screen display device 400 is folded, the first display unit 40 and the second display unit 50 can be rotated such that the third display screen 42 can closely contact the second display screen 51 and overlap with the second display screen 51. The stylus 30 can be connected to the first display unit 40 and the second display unit 50, and the multi-screen display device 400 can display a first user interface which is smaller.

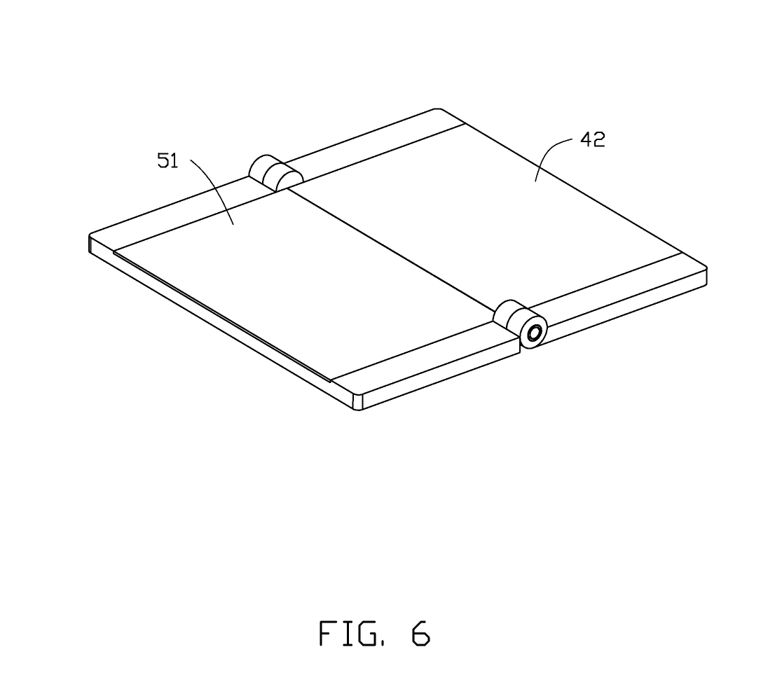

When the stylus 30 is detached, the first display unit 40 and the second display unit 50 can be rotated, such that the third display screen 42 and the second display screen 51 can be located on the same plane. FIG. 6 illustrates that the third display screen 42 is coplanar with the second display screen 51, and the third display screen 42 and the second display screen 51 form an angle of 180 degrees. The third display screen 42 and the second display screen 51 can be closely contact with each other to display a second user interface which is larger than the first user interface, and there is no space between the third display screen 42 and the second display screen 51.

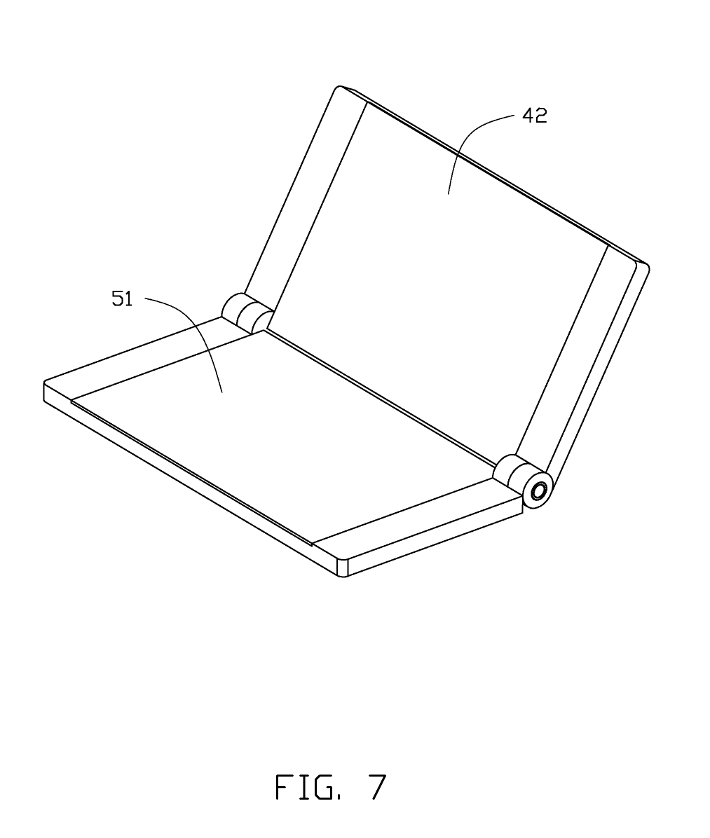

FIG. 7 illustrates that the third display screen 42 and the second display screen 51 can be adjacent to each other and form an angle of about 120 degrees. At this time, the first display screen 41 can be closed, and the multi-screen display device 400 can be used as a laptop. When the second display screen 51 displays the first user interface, the third display screen 42 can display a virtual keyboard. When the third display screen 42 displays the first user interface, the second display screen 51 can display a virtual keyboard. In other embodiments, the angle between the third display screen 42 and the second display screen 51 can be other than 120 degrees.

The multi-screen display device of this disclosure includes the first display unit and the second display unit. As the first display unit and the second display unit can be rotated, the multi-screen display device can form a large screen by adjacently disposing the plurality of the screens. The multi-screen display device has a small size than a conventional large screen display device, and is convenient to carry.

The embodiments shown and described above are only examples. Many details are often found in the art such as the other features of a multi-screen display device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A multi-screen display device comprising:
a first display unit having at least one first display screen; and
a second display unit having at least one second display screen;
wherein, the first display unit is rotatably coupled to the second display unit so that the first display screen and the second display screen are positionable substantially on a single plane; and
wherein, when the first display screen and the second display screen are positioned on a single plane, the first display screen is in close proximity to the second display screen and the first display screen and the second display screen cooperate to form a combined display area larger than the first display screen.

2. The multi-screen display device of claim 1,
wherein the first display unit comprises a first housing, and the first housing comprising a first main body having a first surface and a first side surface adjacent to the first surface;
wherein the first side surface comprises a first pivot and a second pivot protrude from two ends of the first side surface along a direction perpendicular to the first side surface, and the first pivot and the second pivot are coaxial; and
wherein the first pivot and the first main body cooperatively form a first receiving groove, and the second pivot and the first main body cooperatively form a second receiving groove.

3. The multi-screen display device of claim 2,
wherein the second display unit comprises a second housing, and the second housing comprising a second main body having a second surface opposite to the first surface and a second side surface adjacent to the second surface;
wherein the second side surface comprises a third pivot and a fourth pivot protrude from two ends of the second side surface along a direction perpendicular to the second side surface, and the third pivot and the fourth pivot are coaxial; and
wherein the third pivot is received in the first receiving groove, and the fourth pivot is received in the fourth receiving groove.

4. The multi-screen display device of claim 3, wherein the first housing further comprise a control key and sound holes arranged on the first surface; one side of the first pivot away from the second pivot defines an earphone jack, and one side of the second pivot away from the first pivot 114 defines a power port.

5. The multi-screen display device of claim 3,
wherein the first display screen is mounted on the first surface, and the second display screen is mounted on the second surface;
when the first display unit or the second display unit is rotated to make the first display screen opposite to the second display screen, the first display screen or the second display screen displays a first user interface; and
when the first display unit or the second display unit is rotated to make the first display screen and the second display screen located on the same plane, the first display screen is in proximately close to the second display screen to cooperatively display a second user interface larger than the first user interface.

6. The multi-screen display device of claim 3,
wherein the first display unit further comprises a third display screen, the first display screen is mounted on the first surface of the display unit, and the third display screen is mounted on a first display device surface opposite to the first surface;
wherein the second display screen is mounted on a second display surface opposite to the first surface;
when the second display screen and the third display screen form an angle, one of the second display screen and the third display screen displays a first user interface, and the other one displays a virtual keyboard; and
when the first display device and the second display device are located on the same plane, the second display screen is in close proximity to the third display screen to cooperatively display a second user interface larger than the first user interface.

7. The multi-screen display device of claim 1, wherein the multi-screens display device further comprises a stylus, and the stylus comprises a pen holder and a pen point received in the pen holder.

8. The multi-screen display device of claim 7,
wherein the pen holder is half cylinder shaped and comprises a half cylindrical surface, and the pen holder further comprises a volume key, a power button, and a data port arranged on the half cylindrical surface; and
wherein the volume key is configured to control the volume output from the first display unit or the second display unit, and the power button is configured to turn on or shut off the multi-screen display device.

9. The multi-screen display device of claim 8,
wherein the pen holder further comprises a pen holder side surface, one end of the pen holder side surface defines a concave portion, and the concave portion comprises a projection at an opening;
wherein the pen point comprises a main body and a nip positioned at one end of the main body, and one end of the main body adjacent to the nip defines a groove; and
wherein the groove is configured to engage with the projection to prevent the pen point dropping off the pen holder.

10. The multi-screen display device of claim 8, wherein at least one of the first display unit and the second display unit defines at least one slot, the stylus comprises at least one protrusion corresponding to the slot, and the at least one protrusion is engaged to the at least one slot such that the stylus is coupled to the first display unit and the second display unit.
